(19) United States
(12) Patent Application Publication
(10) Pub. No.: US 2007/0105009 A1
(43) Pub. Date: May 10, 2007

(54) Fuel supply monitoring of fuel cell system

(76) Inventors: Volker Harbusch, Munchen (DE); Christoph Sonntag, Vaterstetten (DE); Jens Muller, Munchen (DE); Marcus Preissner, Munchen (DE); Peter Rebenseifner, Olching (DE); Kurt Rothkopf, Munchen (DE); Christian Bohm, Hohenkirchen-Siegertsbrunn (DE)

Correspondence Address: IP STRATEGIES, 12 1/2 WALL STREET, SUITE I, ASHEVILLE, NC, 28801, US

(21) Appl. No.: 10/554,869

(22) PCT Filed: Apr. 22, 2004
(86) PCT No.: PCT/EP04/04287

§ 371 Date: Dec. 8, 2006

(30) Foreign Application Priority Data
May 12, 2003 (EP) 03010619.9

(51) Int. Cl. H01M 2/00

(52) U.S. Cl. 429/65

(57) ABSTRACT

The invention relates to a method and a device for monitoring the fuel supply of a fuel cell system and for protecting said fuel cell system against damage or destruction, if no fuel or insufficient fuel is supplied to the fuel cell system. If the flow of fuel is insufficient for supplying fuel to the fuel cell system or if the fuel reserve falls below a predetermined value, a signal will be output.

### FIELD OF THE INVENTION

The invention relates to a method and a device for monitoring the flow of fuel into a fuel cell system and for protecting said fuel cell system against damage or even destruction if no fuel or an insufficient amount of fuel is supplied to the fuel cell system.

### PRIOR ART

Other than internal combustion engines, fuel cells are already damaged after a short period of time, if they do not have supplied thereto a sufficient amount of fuel and if the respective fuel cell is not switched off in time. The reasons for this are to be seen in fuel cell-specific electro-chemical processes: an oxidation reaction always takes place at the anode of a fuel cell. As long as a sufficient amount of fuel is supplied, said fuel is oxidized. Insufficient fuel supply will, however, result in an undersupply of the fuel cell or of individual cells or cell areas. In these undersupplied areas a different oxidation reaction will now take place: depending in the conditions prevailing, materials of the cell will be oxidatively destroyed (e.g. catalysts, bipolar plates) or/and an electrolysis of water, which may perhaps be present, will take place. This will, in almost any case, have the effect that damage is caused to the fuel cell, said damage being either irreparable or it can be remedied only with an unreasonably high effort and expenditure.

An undersupply with fuel may occur due to a great variety of faults, defects and malfunctions: typical causes are e.g. leaks in the fuel supply line, empty fuel tanks, degraded supply pumps, faulty sensors, incorrect determination of the amount of fuel needed at the moment in question. Even small errors or deviations in the function of individual components, which are per se almost insignificant, may thus lead to a destruction of the normally most expensive component of the overall system.

An undersupply with fuel may, however, also occur during normal operation, e.g. if the fuel reserve in a fuel reservoir is running short. In view of the fact that, for reasons of costs and safety as well as for environmental reasons, it is desirable that a fuel cartridge should be emptied completely before it is disposed of or refilled, the latter is a latent risk in the case of systems in which a fuel cell is operated with a replaceable fuel cartridge. In practice, the fuel cartridge is normally not emptied completely, since damage would be caused to the fuel cell already within a few seconds after the complete emptying of the fuel cartridge. Although some of these fuel cartridges are provided with a filling-level meter, a user cannot reasonably be expected to permanently monitor the filling level of a cartridge (which is often installed in a cartridge compartment).

### DETAILED DESCRIPTION OF THE INVENTION

In view of the above-mentioned problems, it is therefore the object of the present invention to protect fuel cell systems against damage caused by an undersupply with fuel.

This object is achieved by the method according to the present invention defined in claim 1 and by the monitoring device defined in claim 10. The solution according to the present invention is additionally implemented in the case of the fuel cell system disclosed in claim 15.

The method of operating a fuel cell system according to the present invention comprises the following steps: monitoring a flow of fuel into the fuel cell system and/or monitoring a fuel reserve in a fuel reservoir which supplies the fuel cell system with fuel; outputting a signal if the flow of fuel is insufficient for supplying fuel to the fuel cell system and/or outputting a signal if the fuel reserve falls below a predetermined value.

According to the present invention, it is therefore checked, by monitoring the fuel supply, whether an undersupply of the fuel cell system has to be reckoned with in the near or in the foreseeable future. If such an undersupply becomes apparent—because the fuel reserve in a fuel reservoir (if provided) may perhaps run short, or because the flow of fuel in the supply line leading to the system may perhaps decrease or cease completely—there will still be enough time to bring the system or the most sensitive components thereof to a safe operating condition. The signal output may e.g. be an acoustical or an optical warning signal, which requests a user to take the necessary measures. The monitoring can be effected directly in the fuel supply line, e.g. by making use of a flow meter. If the supply of fuel takes place via a fuel reservoir, e.g. a refillable tank or a replaceable cartridge, the monitoring can also be effected—additionally or alternatively—in or on the fuel reservoir, e.g. by means of a filling-level sensor.

In this respect it is not absolutely necessary that the flow rate of the fuel flow is measured absolutely or that the amount of fuel contained in the fuel reservoir is measured absolutely, but the sensors may also be designed such that they are normally “mute” (do not output a signal) and that they will only output a signal if the flow rate lies below a predetermined value or if the filling level lies below a predetermined value (state of emergency). The reverse case or variants is/are, of course, possible as well: that the sensors normally output a signal and cease to output said signal in a state of emergency, or that the sensors normally output a first signal and that they output a second signal, which is different from the fist one, in the state of emergency.

The necessary flow rate and the necessary filling level (which is normally chosen in dependence upon a certain operating time) are, only in the simplest case, predetermined as invariable magnitudes. Preferably, these values are continuously adapted to the current fuel consumption of the fuel cell system via a control unit of said fuel cell system.

The signal can be an acoustical or optical warning signal, or some other kind of warning signal, which is output e.g. directly by the sensor (sensors) and which points out to the operator of the system that measures have to be taken so as to guarantee the additional fuel supply of the system and/or so as to bring the system to a safe operating condition, e.g. by switching off the fuel cell.

The signal may, however, also be an electric or electromagnetic signal (or the like), which is output to the fuel cell system, whereupon precautionary measures will automatically be initiated, e.g. by bringing the fuel cell system to a safe operating condition. The signal can also be output to an external control unit for the fuel cell system, or to a control unit of the fuel cell system, whereupon the control unit will initiate the execution of the necessary measures.

Communication between the sensor(s) and the control unit can take place in both directions so that the control unit can dynamically adapt target values of the sensors to the operating conditions of the fuel cell system and/or can permanently read the current measurement values of the sensor (sensors) or query said measurement values at certain moments in time.

The precautionary measures for protecting the fuel cell system against damage, if the flow of fuel is insufficient for supplying fuel to the fuel cell system and/or if the fuel reserve falls below the predetermined value, can be initiated by an operator/user of the system in response to a respective warning signal. However, as has already been outlined hereinbefore, these precautionary measures are, in accordance with a particularly preferred further development of the present invention, initiated automatically when the signal in question has been output: the signal can, for example, directly cause automatic switching off of the system, or it can be output to a control unit which will initiate suitable precautionary measures.

Alternatively to embodiments in the case of which the (warning) signals are output by the sensor (sensors), variants are particularly advantageous in the case of which the sensor (sensors) transmit(s) only measurement values to a control unit, whereupon said measurement values are analyzed by said control unit and, if the flow of fuel is insufficient for supplying fuel to the fuel cell system and/or if the fuel reserve falls below a predetermined value, the control unit itself emits the signal in question and initiates measures, if necessary. The measurement values transmitted can comprise the flow of fuel and the filling quantity.

When the filling quantity or an equivalent value, such as the filling level, is determined, the control unit can—assuming an average consumption or taking as a basis the consumption at the moment in question—determine the moment in time at which the fuel reservoir will be completely empty; the operator of the fuel cell system can be provided with important information in this way.

Measurement signals need not be output permanently by the sensor, but they may be output at predetermined time intervals or only on request (e.g. by a control unit).

According to particularly preferred further development of the present invention, the initiation of precautionary measures comprises automatic switching over of the fuel cell system to a safe operating condition. This can mean that the fuel cell system is e.g. switched off automatically, but preferably it can also mean that the fuel supply is switched over to an alternative fuel supply unit, e.g. a reserve tank.

A simplification of the whole fuel cell arrangement is achieved by a further development in the case of which a flow of fuel is caused to flow into the fuel cell system by generating a negative pressure in said fuel cell system. In this case, a separate supply pump can be dispensed with. The flow can be regulated by a regulating valve which is controlled by a control unit.

The monitoring device for a fuel supply device of a fuel cell system according to the present invention comprises: a sensor for monitoring a flow of fuel into said fuel cell system, and/or a sensor for monitoring a fuel reserve in a fuel reservoir which supplies the fuel cell system with fuel, and at least one signal generator for outputting a signal.

The signal generator can be a component part of the sensor or of a control unit, or it can be provided as a separate component. The monitoring device is designed for carrying out the method according to the present invention: a signal is output if the flow of fuel is insufficient for supplying fuel to the fuel cell system and/or if the fuel reserve falls below a predetermined value (i.e. the fuel reserve will only suffice to supply fuel to the fuel cell system for a short period of time). A detailed description of the monitoring device and of the further developments thereof does not seem to be necessary in view of the fact that the method according to the present invention has been described in detail hereinbefore.

According to a particularly preferred further development, the monitoring device additionally comprises a control unit for receiving the signal (signals) of the sensor (sensors) and for initiating precautionary measures so as to protect the fuel cell system against damage if the flow of fuel is insufficient for supplying fuel to the fuel cell system and/or for initiating precautionary measures if the fuel reserve falls below the predetermined value.

According to another further development, the sensor for monitoring the flow of fuel into the fuel cell system comprises a flow meter and/or the sensor for monitoring the fuel reserve comprises means for determining the fuel reserve in the fuel reservoir.

The object underlying the present invention is also achieved by a fuel cell system comprising a monitoring device according to the present invention.

The invention will be particularly useful for a fuel cell system which is designed such that it can be supplied with fuel via a replaceable fuel cartridge. It will thus be possible to draw the user's attention to the fact that the fuel cartridge is empty or to inform him of the moment in time at which the fuel cartridge will be empty, so that he can provide a replacement cartridge in time.

Preferably, the fuel cell system comprises a means for generating a negative pressure in the fuel cell system, so that it will not be necessary to provide a supply pump for supplying the flow of fuel to the fuel cell system. The flow of fuel can be controlled by a controllable regulating valve.

Summarizing, it can be stated that the present invention provides a possibility of reliably guaranteeing the supply of a fuel cell with fuel and of rapidly detecting a decrease in or a failure of the supply of fuel—irrespectively of the cause of said decrease or failure—whereby it will be possible to bring the fuel cell to a safe operating condition in time.

In order to illustrate this, the invention will be described in the following on the basis of particularly preferred embodiments making reference to the figure enclosed. It is particularly emphasized that these figures are of a schematic nature and that the embodiments shown therein only serve to illustrate the invention more clearly and must not under any circumstances be interpreted as binding or limiting embodiments.

FIG. 1 shows a typical conventional setup for supplying fuel to a fuel cell system;

FIG. 2 shows a modification according to the present invention of the setup outlined in FIG. 1;

FIG. 3-5: show three simple embodiments for illustrating the method according to the present invention;

FIG. 6: shows a representation of an arrangement for carrying out a particularly preferred method for supplying fuel to a fuel cell system.

In the figures following hereinbelow, identical reference numerals stand for components having identical or comparable functions. In order to avoid unnecessary repetitions, these components and their functions will be described in detail only when they are mentioned for the first time.

FIG. 1 illustrates the setup used for supplying fuel to a conventional fuel cell system. The fuel cell system comprises a fuel cell 1 as a main component. Other components, which will be described hereinbelow, such as control units, pumps, lines, etc., can—depending on expediency—also be provided as internal components of the fuel cell system or as separate, external devices.

The fuel cell 1 is supplied with fuel via a fuel reservoir 3. The fuel cell system is connected to the fuel reservoir 3 via a supply line 2. In the embodiment outlined in the figure, the fuel cell system comprises an anode-side circular flow which is maintained by a circulation pump 20. The circular flow is provided for recovering unconsumed fuel and for maintaining the water balance of the system. Waste products (burn-up products) are separated and disposed of (not shown). A fuel supply pump (dosing pump) 10 is provided in the fuel supply line 2 so as to feed fresh fuel into the anode-side circular flow in accordance with the amount consumed by the fuel cell system.

A defect in one of the pumps 10, 20, an empty fuel reservoir 3, a leak in the supply line 2 or in the circular flow lines may result in an undersupply of the fuel cell 1 of the fuel cell system and in destruction of said fuel cell 1 caused by said undersupply.

FIG. 2 illustrates an embodiment in the case of which the concept underlying the present invention has been implemented in the conventional fuel cell arrangement outlined in FIG. 1.

The arrangement according to the present invention shown in FIG. 2 differs from the prior art arrangement according to FIG. 1 insofar as the fuel supply line 2 has provided therein a sensor 4 which monitors the supply of fuel to the fuel cell system. In the simplest case, the sensor 4 is designed such that it will emit a warning signal, if the fuel through-flow should vanish or fall below a predetermined value or a value that is dynamically adapted to the needs of the fuel cell system. The warning signal draws the user's attention to the fact that measures should be taken so as to protect the fuel cell system and in particular the fuel cell 1 against damage or destruction.

An increased reliability can be achieved, when the sensor 4 and the fuel cell system are, alternatively or additionally, configured such that, in the above-described situation, the sensor will emit a signal which has the effect that the fuel cell system will automatically be brought to a safe operating condition. Such configurations will be described with reference to additional preferred embodiments, which are illustrated in subsequent figures. In FIG. 3, a first embodiment of this type is outlined.

The fuel cell 1 of the fuel cell arrangement outlined in FIG. 3 is supplied with fuel from a fuel feed line 30 having connected thereto a fuel supply line 2. The fuel supply line 2, which branches off from the fuel feed line 30 into the fuel cell system, has provided therein a sensor 4 which monitors the flow of fuel into the fuel cell system. The sensor 4 is connected to a control unit of the fuel cell system via a signal line 5. If the flow of fuel into the fuel cell system falls below a necessary value, the sensor 4 will emit a corresponding signal via the signal line 5, whereupon the control unit initiates the execution of the necessary safety measures. The signal line 5 can also be used for transmitting, continuously or at predetermined time intervals, flow rate values to the control unit of the fuel cell system. Furthermore, it is also possible to transmit signals in the reverse direction from the control unit of the fuel cell system to the sensor 4, e.g. for the purpose of adapting a flow rate target value to the amount of fuel consumed by the fuel cell system at the moment in question.

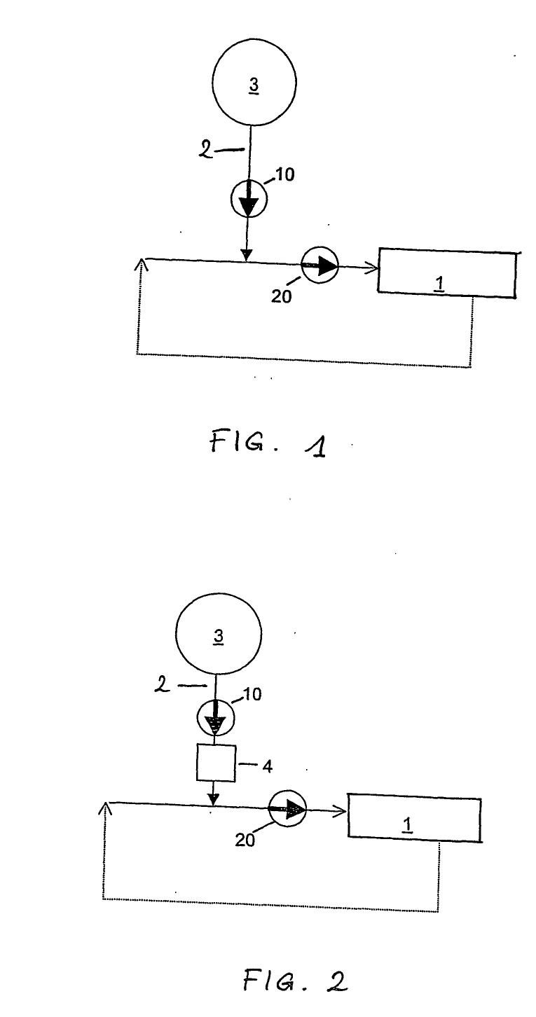

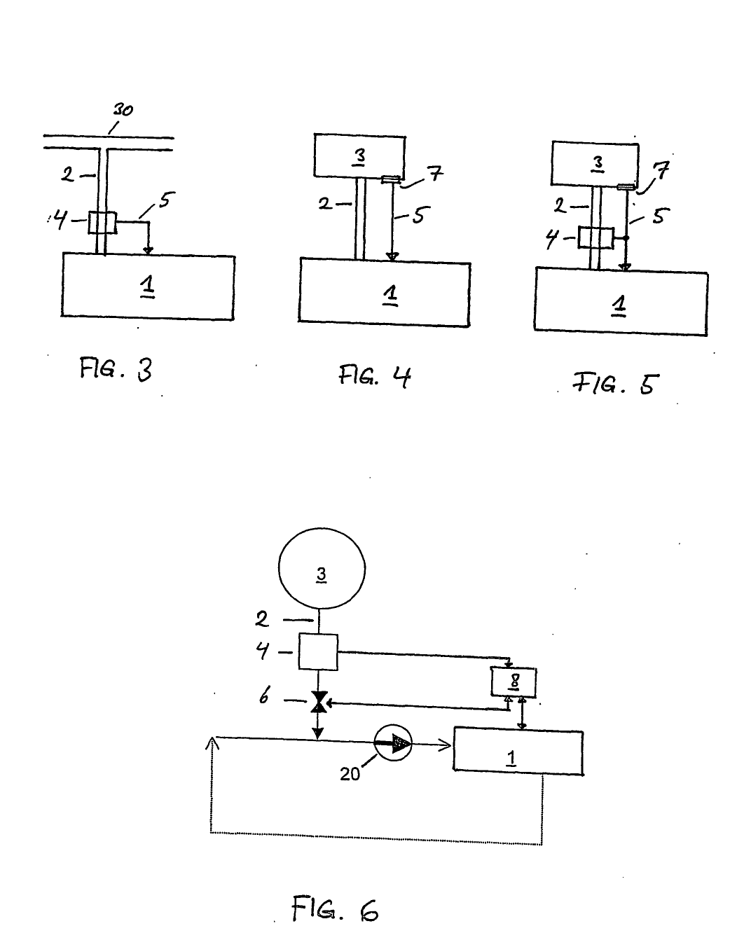

Another exemplary embodiment of the present invention is outlined in FIG. 4.

In the embodiment according to FIG. 4, the fuel is again supplied via a fuel reservoir 3. In the case of the embodiment outlined in said figure, a sensor 7 is provided on or in the bottom of the reservoir 3, said sensor 7 outputting a signal for the control unit of the fuel cell system via the signal line 5, when the liquid level in the fuel reservoir 3 drops to the bottom level.

The principles outlined in FIGS. 3 and 4 are combined in the case of the particularly preferred embodiment shown in FIG. 5. The two sensors 4 and 7 guarantee here that the degree of safety will be increased still further.

Instead of the sensor 7 outlined in FIGS. 4 and 5, it is also possible to provide a filling-level meter which continuously supplies up-to-date values indicative of the fuel reserve in the fuel reservoir 3 to the control unit of the fuel cell system. These values can e.g. be used for estimating when it will be necessary to replace or refill the fuel reservoir 3. The measured values or the values calculated can be indicated and reproduced as useful information on a display device.

FIG. 6 serves to illustrate a further particularly preferred embodiment of the present invention.

The embodiment shown in FIG. 6 can be regarded as a modification of the embodiment outlined in FIG. 2. In FIG. 6 a control unit 8 is explicitly shown. This control unit 8 can be an external control unit, but—and this is preferred—it may also be part of the fuel cell system. It should here be particularly pointed out that such a control unit may also be provided in the case of the above-described embodiments according to FIG. 2 to 5, although it is not explicitly shown in the figures of the embodiments described hereinbefore. In particular, it should be emphasized that the control unit 8 does not represent the essential difference between the embodiments according to FIG. 2 and FIG. 6. On the contrary, the decisive advantage of the further development according to FIG. 6 in comparison with the embodiment according to FIG. 2 is to be seen in the fact that a supply pump in the fuel supply line 2 (in FIG. 2: supply pump 10) can be dispensed with. The system can be simplified substantially and costs can be reduced in this way.

In the embodiment according to FIG. 6, the fuel is sucked into the circular flow of the system by the negative pressure prevailing in the suction line of the circulation pump 20. For this purpose, the suction line can be provided with artificial flow inhibitors (baffles), which support the creation of a negative pressure. A valve 6 in the supply line 2 serves to regulate the desired mass flow and/or volume flow. The fuel flow at the moment in question is measured by means of the sensor 4. The valve 6 is regulated via the control unit 8. If the fuel cell 1 needs an increased amount of fuel, the control unit 8 will control the regulating valve 6 with the aid of the sensor 4 so as to establish a desired value of the amount of fuel supplied.

The present invention and its advantages have been explained hereinbefore on the basis of preferred embodiments. The scope of protection of the present invention is, however, defined solely by the subsequent claims.

1. A method of operating a fuel cell system, comprising the steps:
monitoring a flow of fuel into the fuel cell system and/or monitoring a fuel reserve in a fuel reservoir which supplies the fuel cell system with fuel,
outputting a signal if the flow of fuel is insufficient for supplying fuel to the fuel cell system and/or outputting a signal if the fuel reserve falls below a predetermined value.

2. A method according to claim 1, comprising the additional step:
initiating precautionary measures for protecting the fuel cell system against damage if the flow of fuel is insufficient for supplying fuel to the fuel cell system and/or initiating precautionary measures if the fuel reserve falls below the predetermined value.

3. A method according to claim 1, wherein the monitoring of the flow of fuel comprises the determination of said flow of fuel.

4. A method according to claim 1, wherein the monitoring of the fuel reserve comprises the determination of said fuel reserve in the fuel reservoir.

5. A method according to claim 1, wherein the monitoring of the fuel reserve in the fuel reservoir comprises the determination of a moment in time at which the fuel reservoir will be completely empty.

6. A method according to claim 1, wherein the monitoring comprises the emission of a measurement signal at predetermined time intervals or on request.

7. A method according to claim 2, wherein the initiation of precautionary measures comprises the switching over of the fuel cell system to a safe operating condition.

8. A method according to claim 2, wherein the initiation of precautionary measures comprises the switching over of the fuel supply to an alternative fuel supply unit.

9. A method according to claim 1, wherein the flow of fuel is caused to flow into the fuel cell system by generating a negative pressure in said fuel cell system.

10. A monitoring device for a fuel supply device of a fuel cell system, comprising:
a sensor for monitoring a flow of fuel into said fuel cell system and/or
a sensor for monitoring a fuel reserve in a fuel reservoir which supplies the fuel cell system with fuel.

11. A monitoring device according to claim 10, further comprising:
a control unit for receiving the signal/signals of the sensor/sensors and for initiating precautionary measures so as to protect the fuel cell system against damage if the flow of fuel is insufficient for supplying fuel to the fuel cell system and/or if the fuel reserve falls below the predetermined value.

12. A monitoring device according to claim 10, wherein the sensor for monitoring the flow of fuel into the fuel cell system comprises a flow meter and/or the sensor for monitoring the fuel reserve comprises means for determining the fuel reserve in the fuel reservoir.

13. A fuel cell system, comprising a monitoring device according to claim 10.

14. A fuel cell system according to claim 13, which is designed such that it can be supplied with fuel via a replaceable fuel cartridge.

15. A fuel cell system according to claim 13, further comprising:
a means for generating a negative pressure in the fuel cell system.

16. A monitoring device according to claim 11, wherein the sensor for monitoring the flow of fuel into the fuel cell system comprises a flow meter and/or the sensor for monitoring the fuel reserve comprises means for determining the fuel reserve in the fuel reservoir.

17. A fuel cell system, comprising a monitoring device according to claim 11.

18. A fuel cell system, comprising a monitoring device according to claim 12.

19. A fuel cell system according to claim 14, further comprising:
a means for generating a negative pressure in the fuel cell system.

20. A method according to claim 2, wherein the flow of fuel is caused to flow into the fuel cell system by generating a negative pressure in said fuel cell system.
